(19) United States
(12) Patent Application Publication
(10) Pub. No.: US 2004/0000099 A1
(43) Pub. Date: Jan. 1, 2004

(54) Mood regulation enclosure and methods for use thereof

(76) Inventor: Shlomit Gal, Ramat Gan (IL)

Correspondence Address: DR. MARK FRIEDMAN LTD., C/o Bill Polkinghorn, Discovery Dispatch, 9003 Florin Way, Upper Marlboro, MD, 20772, US

(21) Appl. No.: 10/179,239

(22) Filed: Jun. 26, 2002

(51) Int. Cl. E04H 1/14; E04H 14/00; E04F 19/00; E04H 1/00; A47F 10/00; E04H 3/00; E04H 5/00; E04H 6/00; E04H 9/00; H04M 1/00

(52) U.S. Cl. 52/27.5; 52/28; 379/453; 52/36.1; 52/79.1

(57) ABSTRACT

Mood regulation enclosures and methods of use thereof are disclosed. The mood regulation enclosures include an interior space to contain a user, a closeable aperture and physical barriers which effectively sensorily separate the user from the outside environment. A person observing the enclosure from outside is unable to ascertain an activity of the user within. The enclosure may be specifically configured for aggression release or for passive relaxation. The method of regulating a mood includes providing a mood regulation enclosure as described hereinabove, allowing a user to enter the enclosure so that the user is effectively sensorily separated from the outside environment and preventing a person observing the enclosure from outside from ascertaining an activity of the user within.

### FIELD AND BACKGROUND OF THE INVENTION

The present invention relates to a mood regulation enclosure and methods for use thereof and, more particularly, to an enterable booth that provides a user with an opportunity to isolate themselves from a surrounding environment as a means of regulating their mood. Preferably, the invention further relates to an enclosure which offers a user an opportunity to engage in mood regulating behaviors while remaining unobserved.

Methods for relaxation of tension and concealed aggression have been known in the human behavioral science for years and are used by therapists and psychologists on a routine basis. However such methods are usually used or taught in clinics or during specific lessons/sessions dedicated to that purpose. However, only a small percentage of the population participates in such lessons/sessions. This low participation rate may stem from, for example, lack of local availability, high cost, social stigma or ignorance of an opportunity to participate. Monopolistic behavior of therapists (e.g. psychologists, social workers and psychiatrists) may further contribute to the low participation rate.

A much greater percentage of the population suffers from feelings of stress or un-vented aggression as a result of environmental stimuli. These environmental stimuli may have their origins in the workplace, the home, an academic environment or public places. Often there is a feeling that “If I could just get away for a few minutes, everything would be so much better”. Further, stress may result from unrelieved boredom. However, the opportunity for momentary escape does not often present itself.

Telephone booths are somewhat similar to the enclosures of the present invention. However, a typical telephone booth is not fully soundproof. Further, a user of a typical telephone booth is visible, and sometimes audible, to an observer outside the phone booth. This is often by design to discourage vandalism. Thus, engaging in violent behavior within a phone booth is actively discouraged in a variety of ways by designers thereof. Further, in order to encourage fast turnover, phone booths are often designed to be slightly uncomfortable so that improvement of mood is unlikely to occur when using a phone booth.

Private movie viewing booths are also are somewhat similar to the enclosures of the present invention. However, a typical private movie-viewing booth does not effectively sensorily separate a user thereof from said outside environment. These booths are typically employed to view lewd or pornographic movies. Part of the allure of using such a booth lies in partially perceiving outside observers, for example hearing their voices, while viewing the film. Further, such booths are often equipped with small openings into adjoining booths. Such openings are inconsistent with the purpose and function of the present invention.

There is thus a widely recognized need for, and it would be highly advantageous to have, a mood regulation enclosure and methods for use thereof devoid of the above limitation.

### SUMMARY OF THE INVENTION

According to one aspect of the present invention there is provided a mood regulation enclosure. The enclosure includes: (a) an interior space of sufficient size to contain at least one user therein; (b) a closeable aperture in fluid communication with the interior space and an outside environment; and (c) physical barriers which clearly define the interior space and separate the interior space from the outside environment. The at least one user contained in the interior space is effectively sensorily separated from the outside environment. A person observing the enclosure from the outside environment is unable to ascertain an activity of the user in the interior space.

According to another aspect of the present invention there is provided a method of regulating a mood of a first person. The method includes: (a) providing a mood regulation enclosure including an interior space, a closeable aperture and physical barriers as described hereinabove and hereinbelow; (b) allowing the first person to enter the interior space so that the first person is effectively sensorily separated from the outside environment; and (c) preventing a second person observing the enclosure from the outside environment from ascertaining an activity of the first person in the interior space.

According to yet another aspect of the present invention there is provided an aggression release enclosure. The enclosure includes: (a) an interior space of sufficient size to contain at least one user therein, the interior space being designed and constructed to permit violent activity of the user therein while protecting the user from permanent injury; (b) a closeable aperture in fluid communication with the interior space and an outside environment; and (c) physical barriers which clearly define the interior space and separate the interior space from the outside environment the physical barriers further serving to conceal an activity of the user in the interior space from an observer in the outside environment.

According to still another aspect of the present invention there is provided a relaxation enclosure. The enclosure includes; (a) an interior space of sufficient size to contain at least one user therein, the interior space being equipped with at least one relaxation aid; (b) a closeable aperture in fluid communication with the interior space and an outside environment; and (c) physical barriers which clearly define the interior space and separate the interior space from the outside environment. The physical barriers are designed and constructed to provide effective sensory separation from the outside environment to the user contained in the interior space.

According to further features in preferred embodiments of the invention described below, the physical barriers are soundproof.

According to still further features in the described preferred embodiments the physical barriers are designed and constructed so that the user contained in the interior space is protected from injury if the user strikes the physical barriers.

According to still further features in the described preferred embodiments the closeable aperture is equipped with a lock operable by the user.

According to still further features in the described preferred embodiments the enclosure further includes a fee collection mechanism.

According to still further features in the described preferred embodiments the enclosure further includes at least one item selected from the group consisting of a sound system, an image presentation system, a lighting control system, an aromatherapy system, an ionizer, a temperature control system, a white noise generator, a sound recorder, a video recorder, a printer, a writeable CD drive, a computerized data storage device and a network connection.

According to still further features in the described preferred embodiments the enclosure further includes an aggression target installed within the interior space, the aggression target designed and constructed to withstand blows delivered by the user.

According to still further features in the described preferred embodiments the further includes soundproofing the physical barriers.

According to still further features in the described preferred embodiments the method further includes designing and constructing the physical barriers so that the first person contained in the interior space is protected from injury when striking the physical barriers.

According to still further features in the described preferred embodiments the further includes equipping the closeable aperture with a lock operable by the first person.

According to still further features in the described preferred embodiments the method further includes collecting a fee from the first person.

According to still further features in the described preferred embodiments the method further includes providing to the first person at least one item selected from the group consisting of a sound system, an image presentation system, a lighting control system, an aromatherapy system, an ionizer, a temperature control system, a white noise generator, a sound recorder, a video recorder, a printer, a writeable CD drive, a computerized data storage device and a network connection.

According to still further features in the described preferred embodiments the method further includes providing an aggression target installed within the interior space, the aggression target designed and constructed to withstand blows delivered by the first person.

According to still further features in the described preferred embodiments the at least one relaxation aid includes at least one item selected from the group consisting of a sound system, an image presentation system, a lighting control system, an aromatherapy system, an ionizer, a temperature control system and a white noise generator.

The present invention successfully addresses the shortcomings of the presently known configurations by providing enclosures and methods for use thereof which serve to regulate a mood of a user while assuring privacy of the user. Mood regulation, as used herein, includes, but is not limited to venting of aggression or frustration.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the Drawings:

FIG. 1 is a perspective view of an enclosure according to the present invention. Physical barriers are shown as semi transparent so that a person within the enclosure is visible.

FIG. 2 depicts features of an interior space of an enclosure according to the present invention.

FIG. 3 is a simplified flow diagram illustrating steps in methods according to the present invention.

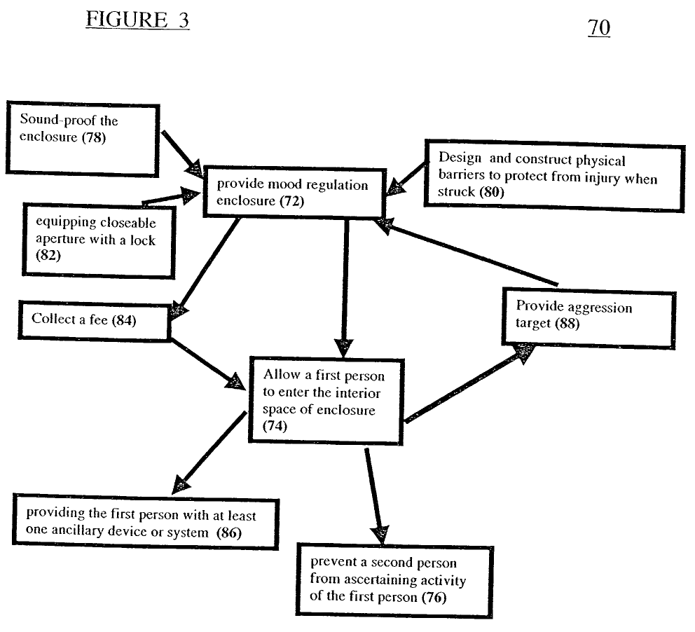

### DESCRIPTION OF THE PREFERRED EMBODIMENTS

The present invention is of a mood regulation enclosure and methods for use thereof which can be entered to provide an opportunity for isolation from a surrounding environment as a means of mood regulation.

Specifically, the present invention offers a user/practitioner an opportunity to engage in mood regulating behaviors while remaining unobserved. This assurance of privacy aids in facilitating release of tension as will be described hereinbelow.

The principles and operation of a mood regulation enclosure and methods for use thereof according to the present invention may be better understood with reference to the drawings and accompanying descriptions.

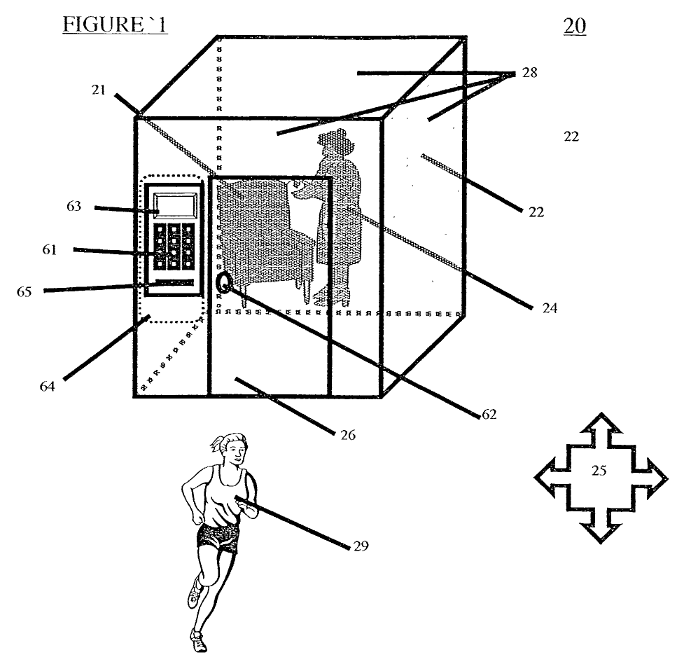

Referring now to the drawings, FIG. 1 illustrates a mood regulation enclosure 20. Enclosure 20 includes an interior space 22 of sufficient size to contain at least one user 24 therein. Enclosure 20 further includes a closeable aperture 26 in fluid communication with both interior space 22 and an outside environment 25. Enclosure 20 further includes physical barriers 28 which clearly define interior space 22 and separate interior space 22 from outside environment 25. User 24 contained in interior space 22 is effectively sensorily separated from outside environment 25. A person 29 observing the enclosure from the outside environment is unable to ascertain an activity of user 24 in interior space 22. In order to provide effective sensory separation between space 22 and environment 25, physical barriers 28 are preferably soundproof.

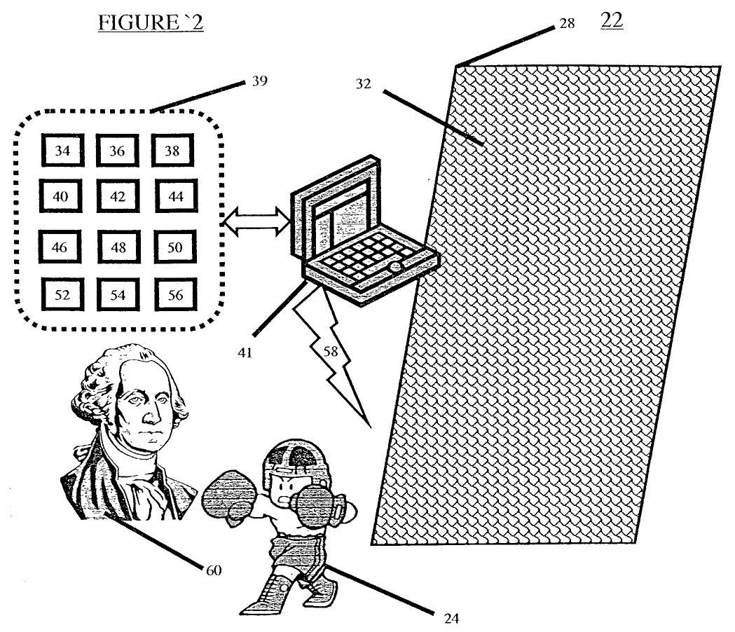

Because user 24 may enter enclosure 20 for the purpose of engaging in violent activity, physical barriers 28 are preferably designed and constructed so that user 24 contained in interior space 22 is protected from injury if user 24 strikes physical barriers 28, for example from within interior space 22 of enclosure 20. This may involve covering part, or all, of barriers 28 with a cushioning or shock absorbing material 32 (FIG. 2). Such a material 32 will additionally serve to soundproof enclosure 20 as detailed hereinabove.

Preferably, closeable aperture 26 is equipped with a lock 62 operable by user 24.

Alternately, or additionally, enclosure 20 further includes a fee collection mechanism 64. For purposes of this specification and the accompanying claims the term “fee” refers equally to money, debit of a monetary account or debit of a non-monetary account (e.g. frequent flyer miles). Fee collection mechanism 64 may include, for example a keypad 61, display 63 and card insertion slot 65. A great variety of fee collection mechanisms are commercially available and one ordinarily skilled in the art will be able to adapt these commercially available mechanisms for use in the context of the present invention. For purposes of this specification and the accompanying claims, the term “display” refers to a device which presents data to a user. Specifically included in the definition are cathode ray tube display screens, liquid crystal displays and light emitting diodes. Although a visual display is pictured, audio display of data is within the scope of the term display as used herein.

According to various preferred embodiments of the invention interior space 22 (see FIG. 2) of enclosure 20 is equipped with at least one ancillary device or system 39. Ancillary devices or systems 39 may include, but are not limited to, a sound system 34, an image presentation system 36, a lighting control system 38, an aromatherapy system 40, an ionizer 42, a temperature control system 44, a white noise generator 46, a sound recorder 48, a video recorder 50, a printer 52, a writeable CD drive 54, a computerized data storage device 56 and a network connection 58.

Some of these ancillary devices or systems 39 have as a common purpose encouraging relaxation. For example sound system 34 and image presentation system 36 might be used in conjunction to provide the sensation of being in a Japanese garden with water bubbling over rocks. Lighting control system 38 dims ambient light in enclosure 20 so that images presented by image presentation system 36 are more clearly visible. Aromatherapy system 40 might add to the garden illusion by providing fragrances of blossoming flowers in conjunction with those presented as visual images. Ionizer 42 might further relax user 24 in a sub-conscious fashion. Temperature control system 44 can be employed to add a tactile dimension to the relaxation experience.

Other ancillary devices or systems 39 have as a common purpose preserving or sharing an experience from inside enclosure 20 (e.g. sound recorder 48, video recorder 50, printer 52, writeable CD drive 54, computerized data storage device 56 and network connection 58).

According to some embodiments of the invention, ancillary devices or systems 39 are operated from a central user input device such as a personal computer 41.

Alternately, or additionally, enclosure 20 includes an aggression target 60 installed within interior space 22. Aggression target 60 is preferably designed and constructed to withstand blows delivered by user 24.

The present invention is further embodied by a method 70 of regulating a mood of a first person 24. The method includes providing 72 a mood regulation enclosure 20 as described hereinabove and hereinbelow. Method 70 further includes allowing 74 first person 24 to enter interior space 22 so that first person 24 is effectively sensorily separated from outside environment 25. Method 70 further includes preventing 76 a second person 29 observing enclosure 20 from outside environment 25 from ascertaining an activity of first person 24 in interior space 22. Preferably, method 70 further includes soundproofing 78 physical barriers 28. Alternately, or additionally, method 70 includes designing and constructing 80 physical barriers 28 so that first person 24 contained in interior space 22 is protected from injury when striking physical barriers 28.

Preferably, method 70 includes equipping 82 closeable aperture 26 with a lock 62 operable by first person 24. Alternately, or additionally, method 70 includes collecting a fee 84 from first person 24. It will be appreciated that fee collecting 84 and locking 82 may be combined into a single step in some embodiments of the invention. The fee collected may be, for example, in proportion to an amount of time spent by user 24 in enclosure 20.

According to various preferred embodiments of the invention, providing 86 at least one ancillary device or system 39 as described hereinabove is part of method 70.

In some cases, method 70 further includes providing 88 an aggression target 60. Typically aggression target 60 is installed within interior space 22 and is designed and constructed to withstand blows delivered by first person 24.

The present invention is further embodied by an aggression release enclosure 20. Enclosure 20 includes an interior space 22 of sufficient size to contain at least one user 24 therein. Interior space 22 is designed and constructed to permit violent activity of user 24 therein while protecting user 24 from permanent injury. Enclosure 20 further includes a closeable aperture 26 and physical barriers 28 as described hereinabove. According to this embodiment of the invention, the ability of physical barriers 28 to conceal an activity of user 24 in interior space 22 from observer 29 in outside environment 25 is especially important.

According to alternate preferred embodiments of the present invention there is provided a relaxation enclosure 20. Enclosure 20 includes interior space 22 of sufficient size to contain at least one user 24 therein. Interior space 22 is equipped with at least one relaxation aid 39. Enclosure 20 further includes a closeable aperture and physical barriers 28 as described hereinabove. According to this embodiment of the invention, physical barriers 28 must provide effective sensory separation from outside environment 25 to user 24 contained in interior space 22.

The at least one relaxation aid 39 may include, for example, a sound system 34, an image presentation system 36, a lighting control system 38, an aromatherapy system 40, an ionizer 42, a temperature control system 44 or a white noise generator 46. Enclosure 20 may further include a comfortable resting place, for example chair 21. In some cases, relaxation aids 39 may be controlled by user 24, for example by means of a central control system 41. Central control system 41 may be, for example, a computer equipped with a graphical user interface. Data input may be, for example, via a keyboard or touch-screen. Alternately, but also preferably, operation of relaxation aid(s) 39 is automatic according to pre-defined parameters. Alternately, and perhaps most preferably, user 24 chooses from among sets of predefined parameters organized in groups defined by descriptive names (e.g. Japanese Garden; Mediterranean Sunset; Caribbean Beach; and Snowy Forest).

Thus, according to various embodiments of the user 24 enters enclosure 20 for either passive relaxation or active venting of aggression or frustration. It is anticipated that enclosures 20 will be most effectively deployed in public places such as workplace, shopping malls, transportation terminals, hotel lobbies and on the street although installation of enclosures 20 in a private dwelling is within the scope of the present invention. Similarly, while user 24 is not required to have training in any specific relaxation technique (e.g. meditation; prayer; yoga), individuals 24 trained in such techniques may derive added benefit from the present invention.

Additional objects, advantages, and novel features of the present invention will become apparent to one ordinarily skilled in the art upon examination of the following examples, which are not intended to be limiting. Additionally, each of the various embodiments and aspects of the present invention as delineated hereinabove and as claimed in the claims section below finds experimental support in the following examples.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A mood regulation enclosure, the enclosure comprising:
(a) an interior space of sufficient size to contain at least one user therein;
(b) a closeable aperture in fluid communication with said interior space and an outside environment; and
(c) physical barriers which clearly define said interior space and separate said interior space from said outside environment;
wherein said at least one user contained in said interior space is effectively sensorily separated from said outside environment; and
wherein a person observing the enclosure from said outside environment is unable to ascertain an activity of said user in said interior space.

2. The enclosure of claim 1, wherein said physical barriers are soundproof.

3. The enclosure of claim 1, wherein said physical barriers are designed and constructed so that said user contained in said interior space is protected from injury if said user strikes said physical barriers.

4. The enclosure of claim 1, wherein said closeable aperture is equipped with a lock operable by said user.

5. The enclosure of claim 1, further comprising a fee collection mechanism.

6. The enclosure of claim 1, further comprising at least one item selected from the group consisting of a sound system, an image presentation system, a lighting control system, an aromatherapy system, an ionizer, a temperature control system, a white noise generator, a sound recorder, a video recorder, a printer, a writeable CD drive, a computerized data storage device and a network connection.

7. The enclosure of claim 1, further comprising an aggression target installed within said interior space, said aggression target designed and constructed to withstand blows delivered by said user.

8. A method of regulating a mood of a first person, the method comprising:
(a) providing a mood regulation enclosure comprising:
(i) an interior space of sufficient size to contain the first person;
(ii) a closeable aperture in fluid communication with said interior space and an outside environment; and
(iii) physical barriers which clearly define said interior space and separate said interior space from said outside environment;
(b) allowing the first person to enter said interior space so that the first person is effectively sensorily separated from said outside environment; and
(c) preventing a second person observing said enclosure from said outside environment from ascertaining an activity of said first person in said interior space.

9. The method of claim 8, further comprising soundproofing said physical barriers.

10. The method of claim 8, further comprising designing and constructing said physical barriers so that the first person contained in said interior space is protected from injury when striking said physical barriers.

11. The method of claim 8, further comprising equipping said closeable aperture with a lock operable by the first person.

12. The method of claim 8, further comprising collecting a fee from the first person.

13. The method of claim 8, further comprising providing to the first person at least one item selected from the group consisting of a sound system, an image presentation system, a lighting control system, an aromatherapy system, an ionizer, a temperature control system, a white noise generator, a sound recorder, a video recorder, a printer, a writeable CD drive, a computerized data storage device and a network connection.

14. The method of claim 8, further comprising providing an aggression target installed within said interior space, said aggression target designed and constructed to withstand blows delivered by said first person.

15. An aggression release enclosure, the enclosure comprising;
(a) an interior space of sufficient size to contain at least one user therein, said interior space being designed and constructed to permit violent activity of said user therein while protecting said user from permanent injury;
(b) a closeable aperture in fluid communication with said interior space and an outside environment; and
(c) physical barriers which clearly define said interior space and separate said interior space from said outside environment said physical barriers further serving to conceal an activity of said user in said interior space from an observer in said outside environment.

16. The enclosure of claim 15, wherein said physical barriers are soundproof.

17. The enclosure of claim 15, wherein said physical barriers are designed and constructed so that said user contained in said interior space is protected from injury if said user strikes said physical barriers.

18. The enclosure of claim 15, wherein said closeable aperture is equipped with a lock operable by said user.

19. The enclosure of claim 15, further comprising a fee collection mechanism.

20. The enclosure of claim 15, further comprising at least one item selected from the group consisting of a sound system, an image presentation system, a lighting control system, an aromatherapy system, an ionizer, a temperature control system, a white noise generator, a sound recorder, a video recorder, a printer, a writeable CD drive, a computerized data storage device and a network connection.

21. The enclosure of claim 15, further comprising an aggression target installed within said interior space, said aggression target designed and constructed to withstand blows delivered by said user.

22. A relaxation enclosure, the enclosure comprising;
(a) an interior space of sufficient size to contain at least one user therein, said interior space being equipped with at least one relaxation aid;
(b) a closeable aperture in fluid communication with said interior space and an outside environment; and
(c) physical barriers which clearly define said interior space and separate said interior space from said outside environment said physical barriers designed and constructed to provide effective sensory separation from said outside environment to said user contained in said interior space.

23. The enclosure of claim 22, wherein said at least one relaxation aid includes at least one item selected from the group consisting of a sound system, an image presentation system, a lighting control system, an aromatherapy system, an ionizer, a temperature control system and a white noise generator.
